(19) United States
(12) Patent Application Publication
(10) Pub. No.: US 2003/0194072 A1
(43) Pub. Date: Oct. 16, 2003

(54) Control of conference bridges

(76) Inventors: John J. MacNamara, Orland Park, IL (US); Ronald Bruce Martin, Carol Stream, IL (US)

Correspondence Address: Werner Ulrich, 434 Maple Street, Glen Ellyn, IL, 60137, US

(21) Appl. No.: 10/120,819

(22) Filed: Apr. 11, 2002

(51) Int. Cl. H04M 3/42

(52) U.S. Cl. 379/202.01; 379/207.02

(57) ABSTRACT

Apparatus and a method for controlling a conference bridge. In response to receipt of a first signal, such as Dual-Tone Multi-Frequency Signal (DTMF), muting a port of a speaker who has captured the bridge. In response to a subsequent signal or a time-out, the speaker's port is unmuted. Advantageously, this arrangement allows conferees other than the speaker to help control the allocation of the conference bridge among the conferees.

### TECHNICAL FIELD

This invention relates to methods and apparatus for controlling telecommunications conference bridges.

### PROBLEM

A conference bridge is used whenever more than two parties are on a voice connection. In order to allow all conferees to hear what is going on, a conference bridge is normally arranged to detect the highest volume talker and connect that person's speech to the other conferees. This simple arrangement leads to a number of problems addressed by Applicants' invention.

### SOLUTION

Applicants have analyzed the major problems arising from the use of conference bridges. The first problem is that if one of the conferees goes on hold, (perhaps to make another call, or to obtain information off-line), the system which responds to the hold request, may play music, which music, if it is basically the highest volume signal, will be what is transmitted to all other conferees. Another problem is that if one of the conferees has a high noise disturbance around that conferee, the high noise disturbance not only disturbs that conferee, but seizes the conference bridge with a result that all conferees will hear the high noise disturbance. Finally, conditions frequently occur wherein one of the conferees tends to “hog” the conference, and because that conferee is an especially loud talker, keeps the other conferees from talking until he/she catches his/her breath.

Today, whenever one of the conferees hogs the conference, other conferees can send touch tone Dual-Tone Multi-Frequency (DTMF) signals to that talker; these signals are passed by the bridge even when the talker has captured the bridge. The DTMF signal is also heard by the talker who can then stop talking to allow others to participate.

Applicants have studied these types of disturbances in the use of conference bridges, and have invented an arrangement for overcoming these disadvantages. In accordance with one preferred embodiment, Applicants have found a way of overcoming these disturbances, and advancing the state of the art in accordance with their invention, wherein any conferee can signal for attention by sending a signal to the conference bridge, which signal is distributed to all conferees. When the signal is received at the conference bridge, the conferee (speaker) who is currently the source of speech signals being heard by the other conferees is temporarily muted, so that this conferee can hear other conferees, but cannot be the speaker who is heard by all other conferees until the temporary situation has been removed. In accordance with one feature of Applicants' invention, the muting is removed upon receipt of a time-out or until the muting is removed by the muted conferee. In accordance with Applicants' preferred embodiment, the signal for muting or unmuting a conferee is any Dual-Tone Multi-Frequency (DTMF) touch tone signal, a flash, or in the case of an ISDN (Integrated Services Digital Network) telephone, a data message to be transmitted in a Signaling System 7 (SS7) envelope. This signal can be a message sent over a control channel to a system controller which passes the appropriate signal or message to the conference bridge.

### BRIEF DESCRIPTION OF THE DRAWING(S)

FIG. 1 is a block diagram illustrating Applicants' invention; and

FIG. 2 is a flow diagram illustrating the operation of Applicants' invention.

### DETAILED DESCRIPTION

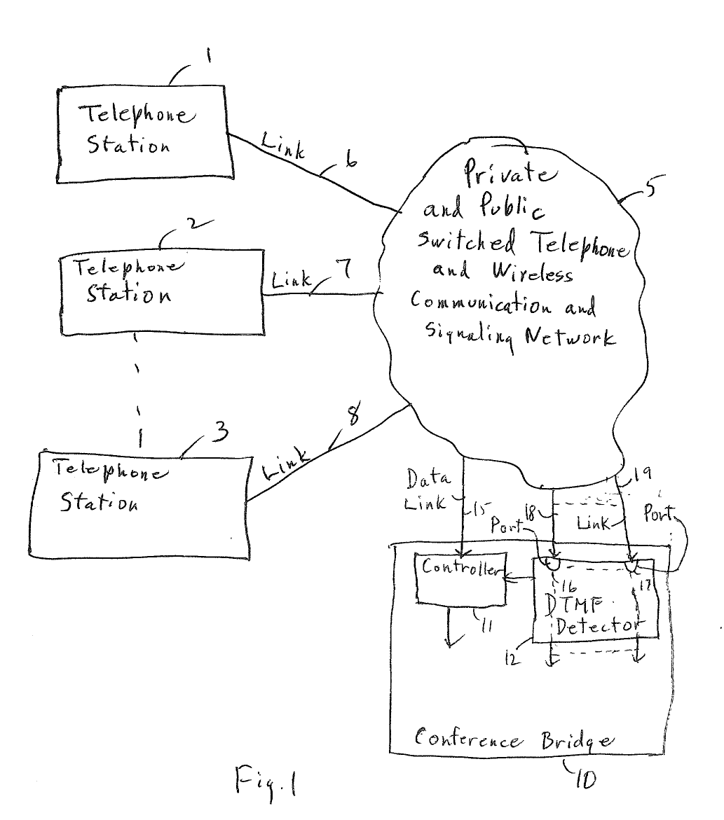

FIG. 1 shows one or more conferees; one, two, . . . , three connected by a private network such as a Private Branch Exchange (PBX), the Public Switched Telephone Network (PSTN), and the Public Switched Wireless Network (5) via a plurality of communication or data links 18, . . . ,19, to a single bridge (10) accommodating a plurality of ports (16, . . . , 17), one port for each conferee.

The bridge is also equipped with a Dual-Tone Multi-Frequency (DTMF) detector, so that if the bridge detects a DTMF signal from any of the conferees, the bridge will automatically mute the present speaker. (Speaker as used herein, is that member of the conference who currently has “captured” the bridge, and whose speech is being transmitted to all other conferees.) When the DTMF detector detects a DTMF tone or tone sequence, the bridge will automatically mute the connection to the current speaker. When a connection is muted, the bridge will not accept incoming signals from the port to which that speaker had been connected, but will transmit the outgoing signals from the bridge to that speaker. However, the bridge will listen for A DTMF signal to allow the muted conferee to request removal of the muting condition. The conference bridge is controlled by a controller (11), which receives signals from DTMF Detector (12). In addition, the controller (11) can receive signals representing data signals for the case in which one of the telephone stations is a station which can send data signals, such as an Integrated Services Digital Network (ISDN) station. Such a station can then send a data signal to the conference port, which data signal is interpreted to represent a request for, for example, muting a speaker. A data signal can be generated in response to the operation of a “soft button”, which automatically causes the station to generate an appropriate data signal. However, the bridge will listen for a DTMF signal to allow the muted conferee to request removal of the muting condition.

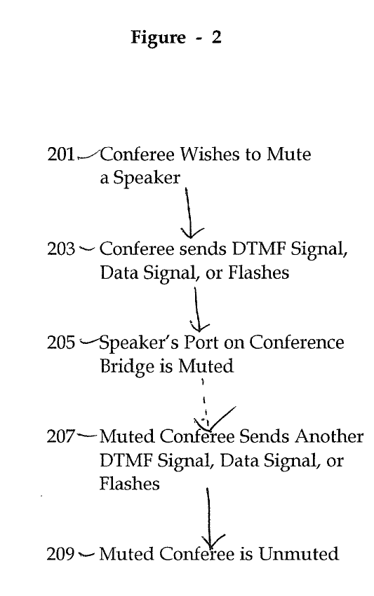

FIG. 2 is a flow diagram illustrating the operation of Applicants' invention. A conferee wishes to temporarily silence a speaker, Action Block (201). The conferee sends a DTMF signal, data signal, or flash, Action Block (203). The bridge mutes the speaker's port, Action Block (205). Sometime later, a muted conferee sends another DTMF signal, data signal, or flash, Action Block (207). In addition, muting can be turned off as a result of a time-out after a pre-determined interval, for example, thirty seconds; after that pre-determined interval, a muted port is automatically unmuted. In response to receipt of that signal, the bridge unmutes the muted conferee, Action Block (209).

In order to make the muting condition acceptable, in accordance with one feature of Applicants' invention, the muted party is periodically notified of the muting by a special tone that is sent only to that party, or a special brief announcement that is sent only to that party. In addition, in accordance with options to be provided to the carrier that owns the bridge, the muting can be released automatically after some time-out.

The description so far has dealt with telephone stations that communicate. by flashes or Dual-Tone Multi-Frequency (DTMF) Signals. Integrated Services Digital Network (ISDN) telephones also communicate, control instructions by data messages sent in response to the operation of a key or button on the ISDN telephone. Such messages, if directed to the bridge, are transmitted as user-to-user elements (UUE) from a Queue.931 message set as defined for ISDN messages. Such messages are sent over the signaling network that is shown herein as being a part of the private and public switched telephone and wireless communications and signaling network (5), and are transmitted to the destination, in this case, the Controller (11) of the Conference Bridge (10). The Controller interprets the received messages and uses them in the same way as the received DTMF messages described above. The Queue.931 message is sent within a Signaling System 7 (SS7) message that is carried by the signaling network within network (5).

In accordance with another feature of Applicants' invention, a special signal can be sent to mute all conference ports except that of the muting party. This would allow the muting party to gain temporary control of the conference bridge; since all other parties are notified of the muting action, they can take steps to unmute the port to which they are connected.

In accordance with an alternative embodiment of the invention, any conferee or a selected conferee, such as a host, can control the muting or unmuting of any other conferee.

In accordance with one feature of Applicants' invention, a muted conferee is periodically reminded of the muting through a signal such as a tone or a flashing lamp. Advantageously, this warns a muted party that he/she will not be heard unless the port of that party is unmuted.

The above description is of one preferred embodiment of Applicants' invention. Other embodiments will be apparent to those of ordinary skill in the art. The invention is limited only by the attached Claims.

1. A method of controlling a conference bridge, comprising the steps of:
responsive to receipt of a signal from one of the conferees, muting a conference port connected to a speaker; and
responsive to receipt of a second signal, unmuting said port of said speaker.

2. The method of claim 1, wherein said signal for muting said port of said speaker is a Dual-Tone Multi-Frequency (DTMF) signal.

3. The method of claim 1, wherein said signal for muting is a data message originated from a station of said one of the conferees.

4. The method of claim 1, wherein said second signal is generated by a station of said speaker.

5. The method of claim 1, further comprising the step of:
transmitting periodically to said speaker, an indication that said port connected to said speaker has been muted.

6. The method of claim 1, wherein said conference port connected to said speaker is automatically unmuted after a lapse of a pre-determined interval of time.

7. A conference bridge comprising:
a signal detector; and
a controller;
said controller responsive to detection of a signal for muting a conference port connected to a speaker; and
said controller responsive to detection of a second signal for unmuting said port of said speaker.

8. The conference bridge of claim 7, wherein said signal detector is a detector for detecting Dual-Tone Multi-Frequency (DTMF) signals, and wherein said controller is responsive to the detection of said signals by said DTMF detector.

9. The conference bridge of claim 7, wherein said signal detector is a detector of data signals, and wherein said controller is responsive to data signals detected by said data signal detector.

10. The conference bridge of claim 7, wherein said controller is responsive to the detection of a lapse of a pre-determined interval of time for unmuting said port of said speaker.
